(19) United States
(12) Patent Application Publication
(10) Pub. No.: US 2021/0032134 A1
(43) Pub. Date: Feb. 4, 2021

(54) FILTRATION SYSTEM AND METHOD FOR REMOVING CONTAMINANTS FROM LIQUIDS

(71) Applicant: Advanced Filter Systems LLC, Oak Brook, IL (US)

(72) Inventors: Terrance O'Malley, Oak Brook, IL (US); Cody Spoolstra, Portage, IN (US)

(21) Appl. No.: 16/942,960

(22) Filed: Jul. 30, 2020

Related U.S. Application Data
(60) Provisional application No. 62/882,039, filed on Aug. 2, 2019.

(51) Int. Cl. C02F 1/62; C02F 1/40; C02F 1/28; C02F 1/00; C02F 1/44

(52) U.S. Cl. CPC C02F 1/62; C02F 1/40; C02F 2101/20; C02F 1/004; C02F 1/444; C02F 1/281

(57) ABSTRACT

The present disclosure relates to a filtration system and method for removing contaminants from liquids, including industrial waste liquid. Specifically, the present disclosure relates to a filtration system and process for removing heavy metals and other contaminants from liquids, such as wastewater from industrial and manufacturing processes, resulting in a useful purified liquid. The present disclosure further relates to a filtration system and method for removing commonly-found contaminants from ethanol, including high proof alcohol and wine.

### TECHNICAL FIELD

The present disclosure relates to a system and method for removing contaminants from liquids. Specifically, the present disclosure relates to a filtration system and process for removing heavy metals, pesticides, and other contaminants, including a variety of chemical contaminants, primarily from water. The result is a highly purified drinkable water. Additionally, the present disclosure relates to a system and method for removing contaminants, including acids, sulfur compounds and pesticides from ethanol, resulting in an alcoholic beverage with potentially fewer side effects for individuals sensitive to those contaminants commonly found in alcoholic beverages.

### BACKGROUND

Water is a precious commodity, required to sustain life and industry. Water quality and contamination issues are a concern in providing quality drinking water, as well as in treating waste water resulting from multiple industries, including, but not limited to, agriculture, oil tank farms, hospitals and research facilities. For example, oil refineries require accurate cleaning of the refinery tanks. These tanks handle and store hundreds of thousands of gallons of crude oil. Over the years, sediment, or sludge, accumulates in the tanks. The sludge is produced from the molecules of water and heavy oil that form in suspension. As the molecules get heavier, they eventually drop to the bottom of the tank. If sludge enters the oil distribution system, it can collect and plug the fuel unit, the nozzle line, or the nozzle. Therefore, it is important to provide a process and system for cleaning and purification of the tanks, and for treatment of the resulting contaminated water.

The present filtration system and process is useful in removing heavy metals and other contaminants from wastewater, for example, wastewater from industrial and manufacturing sources. The present process is useful in the following applications: terminal cleaning for removal of sulfur; water purification including cleaning and purifying water, especially focusing on removing sulfur and lead from water; petroleum refining and water treatment, including processing sour water which may be contaminated with hydrocarbons, hydrogen sulfide, ammonia, organic sulfur compounds, organic acids, and phenol. Process water is treated in an advanced filtering system to remove hydrocarbons, hydrogen sulfide, ammonia, arsenic and other compounds. Ultra-purification of contaminated water may result in purified, potable water, and contributes to conservation of a vital resource.

The present disclosure also relates to a filtration system and method to provide solutions for removing various forms of contaminants from liquids, including industrial wastewater. The present filtration system and process separates and removes oil, heavy metals and other contaminants from industrial wastewater, including, but not limited to, sulphates, pesticides, iron, nitrates, zinc chromium, lead, calcium, potassium, strontium and benzene.

The present disclosure also provides a system and method for removal of sulfur compounds and pesticides from ethanol. This process may be beneficial for use in the alcohol production industry, as the presence of sulfur compounds and pesticides in alcoholic beverages can potentially cause health issues in sensitive individuals. For example, some individuals are sensitive to the sulfite content in wine, which may cause headaches or other side effects. The present method and filtration system may provide removal of 100% of sulfur compounds from ethanol, as well as reduce many kinds of pesticides, without effecting the characteristics and quality of the end product.

The present filtration systems and methods offer the following advantages over prior systems and methods including: a streamlined process, environmental-friendly solutions, decrease maintenance time of machinery, reduced downtime of machinery, reduced disposal expenses, an overall increase in production efficiency and preservation of a vital resource. Additionally, the present filtration system and methods for removing sulfur compounds and pesticides from alcohol may reduce the instances of side effects in consumers sensitive to contaminants found in alcoholic beverages, making for a more enjoyable drinking experience.

### SUMMARY

The present disclosure relates to filtration systems and methods for removing contaminants from liquids. Specifically, the present disclosure relates to a filtration system and process for enhanced water purification particularly with regard to industrial wastewater. The present filtration system and method is designed to remove various target contaminants, including but not limited to water soluble heavy metal species, heavy oil contaminants, sulfur compounds, lead, and pesticides. The resulting highly-purified liquids may be reused in a variety of applications, including industrial and manufacturing applications, and may further be purified to the point of being a consumable product.

Additionally, the present disclosure relates to a filtration system and method for removing sulfur compounds and pesticides from ethanol. Purified ethanol may be advantageous for the alcohol production industry, as the presence of sulfur compounds and pesticides in alcoholic beverages may cause health issues in individuals sensitive to those contaminants routinely found in alcoholic beverages.

To this end, in an embodiment of the present disclosure, a filtration method for removing contaminants from liquids is disclosed. The method includes the steps of: providing a tank for receiving a liquid containing heavy metal and other contaminants; injecting nitrogen under pressure into tank where the nitrogen mixes with the contaminated liquid to initially break up the heavy metals and other contaminants in the liquid; passing the liquid through a first filter disposed at an angle within the tank for effectively separating any oil collecting on a top surface of the liquid flow from the heavy metals/minerals, which collect near the bottom of the tank and liquid flow; further passing the liquid flow through a second filter positioned downstream from the first filter, the second filter being a granule filter, containing sorbents. The sorbents in the granule filter capture the heavy metals and contaminants as the liquid flow passes through the filter. The result is an end liquid free of heavy metals and contaminants, which is potentially suitable for consumption or subsequent uses requiring a liquid with a high purification level. As an additional step, the granule filter can be backwashed, thereby releasing the heavy metals from the filter and capturing the heavy metals for recycling.

In the present embodiment of the filtration system, at least one additional filter such as a microfiltration filter, or multiple microfiltration filters can be positioned downstream from the second filter and at the end of the filtration system. The microfiltration filters provide a higher level of filtration of the liquid, potentially resulting in a potable end liquid.

In another embodiment, a filtration system for removing contaminants from water is disclosed. The filtration system comprises a tank having an interior for receiving a water flow containing contaminants, the water flow under a suitable pressure to pass through a first filter configured to separate any oil from heavy metals in the water flow, a second filter operatively coupled downstream and in sequence with the first filter, the second filter incorporating a sorbent allowing the water flow to pass through the filter while capturing any heavy metals onto the sorbent, and, a plurality of microfilters operatively coupled downstream and in sequence with the second filter, the microfilters configured for ultra-purification of the water flow.

In yet another embodiment, a filtration system is provided for removing sulfur compounds and pesticides from alcohol, such as wine. The system comprises a tank having an interior for receiving an alcohol flow under a suitable pressure, a granule filter disposed within the interior of the tank to receive the alcohol flow, and, a series of microfiltration filters operatively coupled to the tank for receiving the alcohol flow from the tank after passing through the granule filter. The present system is capable of removing at least half the sulfur present in the alcohol, without effecting the taste and characteristics of the alcohol.

It is, therefore, an advantage and objective of the present disclosure to provide an improved filtration system and method for removing contaminants from liquids. Specifically, it is an advantage and objective of the present disclosure to provide a filtration system and method for removing a variety of contaminants, including oil, lead, arsenic, benzene, sulfur, chromium, salt, chlorides, etc. from contaminated waste liquid, such as those found in various industries, including petroleum refining and chemical industries, resulting in a highly purified liquid. The present filtration system and method is particularly advantageous for use in purifying contaminated wastewater.

It is yet another advantage and objective of the present disclosure to provide a filtration system and method for commercial water filtration, removing lead and providing up to 99.99% lead-free water.

It is a further advantage and objective of the present disclosure to provide a filtration system and method for removing sulfur compounds and pesticides from ethanol, including, for example, high proof ethanol and wine, resulting in a consumable alcoholic beverage with reduced contaminants. Reducing commonly found contaminants in an alcoholic beverage may potentially reduce certain side-effects to consumers sensitive to the target contaminants. Specifically, some consumers have allergies or reactions to sulfites commonly found in wine. The present system and method reduce the level of sulfur in wine without effecting the taste and characteristic of the wine.

Additional features and advantages of the present disclosure are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a schematic of a filtration system useful for filtering heavily contaminated waste liquids according to the present disclosure; and,

FIG. 2 illustrates a filtration system useful for filtering sulfur compounds and pesticides from ethanol according to the present disclosure.

### DETAILED DESCRIPTION

The present disclosure relates to a filtration system and method for removing contaminants from liquids. Specifically, the present disclosure relates to a filtration system and method for enhanced liquid purification, including removing oil, lead, water soluble heavy metal species and other contaminants from liquids including water or wastewater contaminated from a variety of manufacturing and industrial sources such as petroleum tank farms, pipeline header systems and water and chemical processing plants. The present filtration system and method is further designed to remove up to 99.99% sulfur and lead from these heavily contaminated water sources, resulting in a highly purified liquid.

The present disclosure further relates to a filtration system and method for removing contaminants, such as sulfur compounds, pesticides, heavy metals from ethanol, including high proof ethanol and wine. The system and method for removing commonly-found contaminants from ethanol would be advantageous to the alcoholic beverage industry, as removal of target contaminants may results in beverages having less side effects to individuals sensitive to these common contaminants.

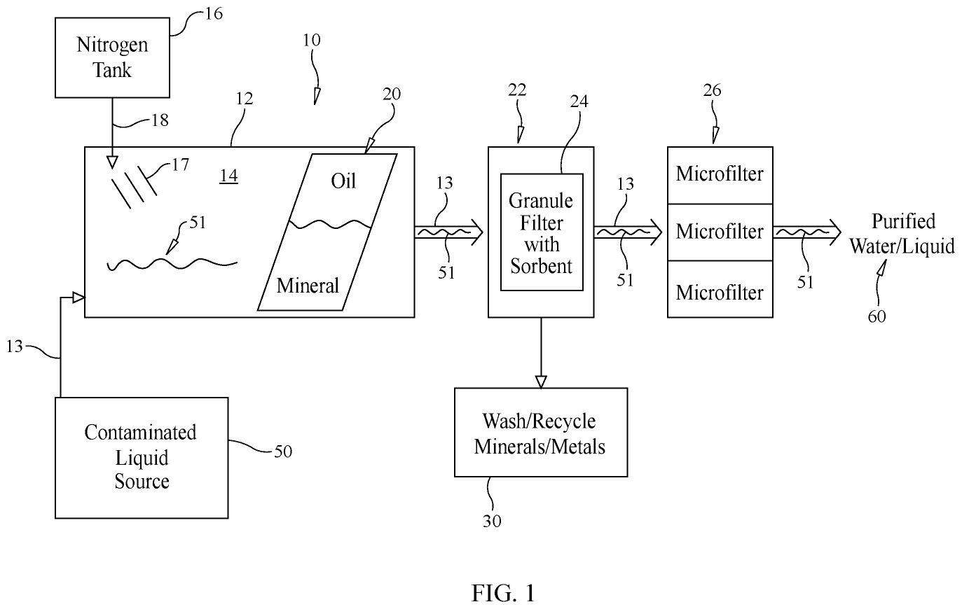

Referring now to FIG. 1, there is shown an embodiment of a filtration system 10 useful in the method of removing contaminants from a liquid. The present filtration system 10 is proposed to handle anywhere from 60,000-150,000 gallons of contaminated liquid. In the present disclosure, contaminated industrial wastewater will be discussed as an example of a contaminated liquid; however, it should be understood that the process can be used for filtering a variety of contaminated liquids as well as capable of handling a variety of different contaminants in solutions.

Examples of contaminants targeted by the present filtration system and method include sulfur compounds, pesticides, acids, various heavy metals, including arsenic, lead, and chromium, benzene, which are all examples of contaminants routinely found in industrial and manufacturing waste streams. The filtration and absorption time of the target contaminants from the subject liquid will vary depending on the volume passing through the filtration system 10, as well as, the concentration level and types of contaminants in the liquid.

The filtration system 10 of the present disclosure includes a tank 12 having an interior 14 having a suitable volume for receiving the contaminated liquid 50. The contaminated liquid 50, such as wastewater may be stored in a vat, oil tank, tanker truck, or another suitable container, which is pumped into to the tank 12 through known conduit 13 and connecting attachments. Initially, the subject liquid is pumped into the interior 14 of the tank 12, where the liquid flow 51 hits and disperses within the interior of the tank. When filtering oil heavy aqueous waste streams from industry, it is advantageous to add nitrogen at the beginning of the filtration system. Thus, in the present embodiment, a nitrogen tank 16 is connected to the tank 12, and nitrogen 17 is simultaneously injected through a nozzle 18 into the interior 14 of the tank 12 at pressures ranging from 200-600 lbs as the liquid flow 51 enters the tank. The nitrogen injection pressure can vary depending on the amount of liquid in the tank 12 and the subject contaminants. The pressure injected nitrogen 17 mixes with the dispersing liquid flow 51 within the tank 12, wherein the nitrogen effectively initially breaks up the subject contaminants, which are present in the liquid.

An initial goal is to separate any oil that may present in the liquid from heavy metals that may present in the liquid flow 51 As the water continues flowing through the tank 12, it reaches a first filter 20 which is a coalescing plate oil/water separator. Coalescing plates are known for separating oil from liquids including water. As liquid flow 51 passes through the coalescing plate separator 20, any oil in the liquid flow rises to the top or surface, while any heavy metals/minerals flow to the bottom of the tank. Use of the coalescing plate 20, and its positioning at an angle (approximately 60° angle) within the tank enhances the separation of oil from the heavy metals/minerals/lead in the liquid flow.

As shown in FIG. 1, a second filter 22 is positioned downstream and in sequence to the first filter or coalescing plate separator 20. The second filter 22 is a granule filter, which contains a sorbent 24. Sorbents are essentially inert and insoluble materials that are used to remove hazardous substances from liquids including water through adsorption, in which the hazardous substance is attracted to the sorbent surface and then adheres to it, or through absorption, in which the hazardous substance penetrates the pores of the sorbent material, or a combination of the two. The types of sorbents 24 useful in the present filtration system 10 are granules of approximately 50% porosity having a composition containing ferrous compounds among other minerals and oxides. The sorbents may be packed into a separation column or settled into a bed at the bottom of the tank.

The sorbents 24 in the granule filter 22 of the present system 10 are configured for capturing the heavy metals separated from the liquid flow 51 as it passes through the second filter under a suitable pressure. Heavy metals absorbed into sorbent 24 can be subsequently washed from the granule filter 22 through application of high-pressure nitrogen or water as a backwash. The recovered metals can then be captured for recycling 30. This recycling step further enhances the environmentally-friendly aspect of the present filtration system 10.

The first filter 20 and the second filter 22 are configured to remove the majority of contaminants from the liquid flow 51. As a final step in the filtration process, and to further enhance the purity of the final liquid 60, at least one third filter 26 is provided. The third filter 26 is a microfiltration filter, generally having a 0.5 micron pore size. The third filter 26 is connected in sequence and downstream from the second filter 22. Optionally, multiple microfiltration filters 26 are used in the final filtering step, as each filter provides an enhanced level of purity to the final product. The liquid flow 51 passes through the additional microfiltration filter 26 or filters, removing any further materials and/or contaminants (if any) remaining in the liquid flow. The result is highly-purified liquid 60 useful for any number of applications, including industrial and manufacturing applications. The purified liquid 60 may also be suitable for consumption.

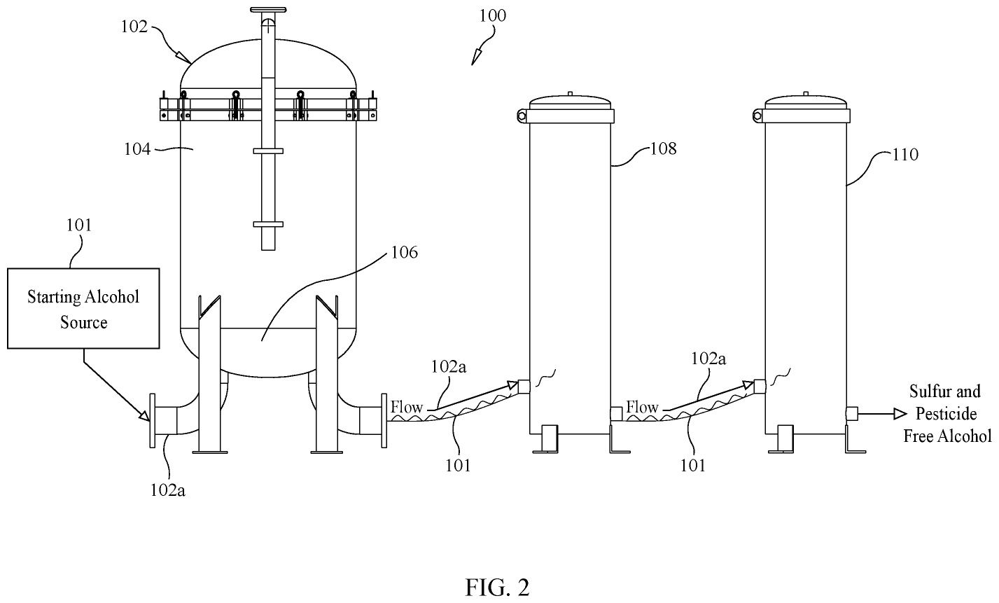

In another embodiment of the present disclosure, a filtration system 100 and method useful for removing acids, pesticides, and sulfur compounds from denatured ethanol 101 is shown in FIG. 2. Between 100-10,000 gallons of ethanol (up to 10 gallons per minute) can be effectively run through the present filtration system 100. The ethanol filtration system 100 generally includes a tank 102 having an interior 104 with a volume suitable for receiving a starting alcohol 101, such as a high proof ethanol (195-200 proof) or wine, which is pumped into the tank from a source (not shown) using a pump (not shown) through a conduit 102a using suitable pressure not exceeding 100 psi.

The tank 102 further include a first granule filter 106 positioned within the interior 103. The granule filter 106 includes a proprietary blend of sorbents using granules of approximately 50% porosity and a composition containing ferrous compounds among other minerals and oxides, which initially capture sulfur, heavy metals, pesticides, acids and other contaminants as the alcohol flows through the tank 102.

As shown in FIG. 2, a second filter 108 is connected through conduit 102a to the tank 102. The second filter 108 positioned downstream from the tank, is a microfiltration polypropylene filter, having generally a 0.5 micron pore size. Additionally, a third filter 110 is connected in sequence and downstream to the second filter 108. The third filter is also a microfiltration polypropylene filter having a 0.5-1.0 micron pore size. As the alcohol stream 101 leaves the tank after passing through the granule filter 106, it flows through the second filter 108 and then through the third filter 110. Any remaining impurities in the alcohol stream 101 are removed. Typically, a single pass through the present filtration system 101 is effect for removing up to one-half the amount of sulfur compounds in the alcohol sample.

Filtering sulfites from ethanol may be useful in the alcohol industry, particularly with regard to wine, because sulfites in wine sometimes cause negative side effects, like nasal congestion, itchy throat, runny nose, skin rash, hives, as well as potentially causing asthma symptoms in individuals sensitive to sulfites. Removing or decreasing the amount of sulfur compounds and pesticides from alcoholic beverages may be useful in diminishing, or even potentially eliminating the physical side effects those contaminants may have on sensitive individuals.

Use of the present filtration system 100 for alcohol has been shown to diminish the level of sulfites, and potentially pesticides, to nearly undetectable limits. The following shows the results of one such test after an alcohol sample was passed through the present filtration system:

MATERIAL: 2 Ea. 200 Proof Alcohol Samples - Samples A & B
SUBJECT: Sulfur Analysis
METHOD: 200.7 (ICP-AES)
UNITS: Milligrams per Liter (mg/L)

| RESULTS: | | |
|---|---|---|
| ANALYTE | SAMPLE A | SAMPLE B |
| Sulfur | <0.12 ppm | 1.39 ppm |

The above results show the effectiveness of the present filtration system 100 in achieving a nearly undetectable sulfur level of less than 0.12 ppm from an already low starting point of 1.39 ppm in a 200 proof alcohol sample. The resulting alcohol sample has nearly negligible sulfur content without diminishing the product quality.

As well, filtering wine using the present filtration system 100 results in sulfur levels of about half the original amount. When filtering wine it is important not to over-filter the wine, as it may change the natural properties and characteristics of the wine. Therefore, the goal is typically to eliminate about half the original amount of sulfur in the wine, while maintaining the characteristics of the particular wine.

The following shows the results of filtering white and red wines through the present filtration system, using ASTM D2622 testing method:

Sample A1—White Wine before filtration sulfur content: 91.0 mg/k

Sample A2—White Wine after filtration sulfur content: 61.0 mg/kg

Sample B1—Red Wine before filtration sulfur content: 112 mg/kg

Sample B2—Red Wine after filtration sulfur content: 55.0 mg/kg

As demonstrated by the above results, the present filtration system 100 is capable of achieving a significant reduction in sulfur content. Reducing the sulfite content typically found in wine, may be effective in reducing the side-effects to those individuals having sensitivities or allergies to sulfites and other contaminants.

It should be noted that various changes and modifications to the presently preferred embodiments described herein will be apparent to those skilled in the art. Such changes and modifications may be made without departing from the spirit and scope of the present disclosure and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A method for removing contaminants from liquid, the method comprising the steps of:
providing a tank for receiving a flow of liquid containing contaminants;
injecting nitrogen under pressure into the liquid flow within the tank;
mixing the nitrogen with the liquid flow;
passing the liquid flow through a first filter configured for separating any oil from heavy metals in the liquid flow;
passing the liquid flow through a second filter positioned downstream to the first filter, the second filter configured for capturing the heavy metals from the liquid flow; and,
collecting an end liquid free of contaminants.

2. The method of claim 1, wherein the method further comprises positioning the first filter at an angle within the tank and to a direction of the liquid flow.

3. The method of claim 2, wherein the first filter is a coalescing plate oil/water separator.

4. The method of claim 1, wherein the second filter is a granule filter.

5. The method of claim 3, wherein the granule filter contains a blend of sorbents.

6. The method of claim 4, wherein the sorbents comprise granules of approximately 50% porosity and a composition containing ferrous compounds.

7. The method of claim 4, wherein the method further includes capturing and separating the heavy metals from the liquid flow using the sorbents on the granule filter.

8. The method of claim 6, wherein the method further includes backwashing the sorbents thereby releasing the heavy metals from the granule filter and collecting the heavy metals for recycling.

9. The method of claim 1, wherein the method further includes providing at least one microfiltration filter downstream to the second filter.

10. The method of claim 8, wherein the method further includes providing a plurality of microfiltration filters in sequence.

11. A system for removing contaminants from water, the system comprising:
a tank having an interior for receiving a water flow containing contaminants;
a first filter positioned within the interior of the tank, the first filter configured to separate any oil from heavy metals in the water flow;
a second filter operatively coupled in sequence with the first filter, the second filter incorporating a sorbent configured for capturing heavy metals in the water flow; and,
a plurality of microfiltration filters operatively coupled in sequence with the second filter, the microfiltration filters configured for ultra-purification of the water flow.

12. The system of claim 11, wherein the first filter is positioned to the water flow for separation of oil from heavy metals.

13. The system of claim 11, wherein the second filter adsorbs and removes heavy metals from the water flow.

14. The system of claim 13, wherein the second filter is backwashed to remove and collect the heavy metals for recycling.

15. A system for removing contaminants from alcohol, the system comprising:
a tank having an interior for receiving an alcohol flow;
a granule filter disposed within the interior of the tank and positioned to receive the alcohol flow; and,
a series of microfiltration filters operatively coupled in sequence to the tank for receiving the alcohol flow from the tank after passing through the granule filter.

16. The system of claim 15, wherein the granule filter and microfiltration filters are configured for removal of up to one-half an amount of contaminants from the alcohol.

17. The system of claim 15, wherein the granule filter incorporates a sorbent.

18. The system of claim 17, wherein the sorbent is a composition of ferrous compounds.

19. The system of claim 15, wherein the alcohol is wine.

20. The system of claim 19, wherein the system is configured to remove up to one-half an amount of sulfites from the wine.
